(19) United States
(12) Patent Application Publication
(10) Pub. No.: US 2007/0256014 A1
(43) Pub. Date: Nov. 1, 2007

(54) Multimedia Processing Apparatus an Method for Adjusting the Audio Level of Multimedia Content

(75) Inventor: Thomas L. Du Breuil, Ivyland, PA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(73) Assignee: GENERAL INSTRUMENT CORPORATION, Horsham, PA (US)

(21) Appl. No.: 11/686,039

(22) Filed: Mar. 14, 2007

Related U.S. Application Data
(60) Provisional application No. 60/788,201, filed on Mar. 31, 2006.

(51) Int. Cl. G06F 3/00

(52) U.S. Cl. 715/716

(57) ABSTRACT

A multimedia processing device and method for adjusting audio levels of program channels of multimedia content to reduce audio level disparities between multimedia content program channels. The method includes generating audio adjustment or offset information for at least one multimedia content program channel, and adjusting audio levels of the program channels based on the audio adjustment information. The audio adjustment information can be based on audio level samples taken from the multimedia content program channels or other suitable information. The audio adjustment information can be metadata transmitted as part of or separately from the multimedia content. The audio adjustment information also can be included within or associated with a channel map, as part of an additional channel map parameter, or in another method. The multimedia processing device, such as a set-top box, is configured to adjust the audio level of the received program channels of multimedia content.

### CROSS-REFERENCE TO RELATED APPLICATION

This application claims priority to the filing date of a U.S. provisional patent application having Ser. No. 60/788,201, entitled “SET TOP AUDIO PERFORMANCE IMPROVEMENT”, filed on Mar. 31, 2006, which is incorporated herein by reference in its entirety.

### BACKGROUND OF THE INVENTION

1. Field of the Invention

The invention relates to multimedia processing devices, such as set-top devices. More particularly, the invention relates to multimedia processing devices that can adjust the audio levels of one or more program channels of multimedia content received by the multimedia processing devices.

2. Description of the Related Art

Multimedia processing devices, such as video and multimedia converter/decoder (set-top box) devices, continue to provide more features and functionality to end users, including the ability to improve the quality of multimedia content received by the multimedia processing devices and subsequently displayed to the end user, e.g., via an end user display device, such as a television screen or computer monitor. Within the multimedia content received by multimedia processing devices, there can be significant differences in the audio levels of the various program channels. That is, the audio level of multimedia content, e.g., a video stream feed from an end user's local cable television company, can vary from program channel to program channel. Such variance, which can occur in both digital and analog program channels, can be disconcerting to end users who may be attempting to watch one or more program channels and/or changing between various program channels.

Conventional attempts to remedy this problem usually make adjustments to modulators in the headend and/or in the uplink encoders. However, such attempts seem to be only partially successful. Other technologies that exist for eliminating or reducing the difference in audio levels of different programs within a single program channel, such as dynamic range limiters/compressors and automatic level control (ALC) circuits, have been somewhat helpful in also addressing audio level differences between program channels. However, many of these technologies tend to introduce some audio artifacts into the program channel content, and therefore seem to be only partially successful. Moreover, some audio artifacts are sufficiently disturbing to some listeners that those listeners will bypass or turn off such processing instead of tolerating the artifacts.

### BRIEF DESCRIPTION OF THE DRAWINGS

FIG. 1 is a block diagram of a system for adjusting audio levels of program channels of multimedia content, including a multimedia processing device for use in adjusting audio levels of program channels of multimedia content; and

FIG. 2 is a flow chart that schematically illustrates a method for adjusting audio levels of program channels of multimedia content.

### DETAILED DESCRIPTION

In the following description, like reference numerals indicate like components to enhance the understanding of the multimedia processing device and method for adjusting audio levels of program channels of multimedia content through the description of the drawings. Also, although specific features, configurations and arrangements are discussed herein below, it should be understood that such specificity is for illustrative purposes only. A person skilled in the relevant art will recognize that other steps, configurations and arrangements are useful without departing from the spirit and scope of the invention.

The device and methods described herein involve adjusting the audio level of one or more program channels of multimedia content, e.g., a broadcast video stream, to reduce or even eliminate audio level disparities between program channels. A multimedia processing device, such as a set-top box or other suitable multimedia processing device, includes a processor configured to adjust the audio level of one or more program channels of multimedia content received by the multimedia processing device. The multimedia processing device can be configured to automatically adjust the audio levels of one or more program channels using audio adjustment or offset information, which can be based on pre-adjustment analysis of audio level samples of one or more program channels, or other suitable means. Alternatively, the multimedia processing device can be configured to allow manual adjustment of one or more program channels, e.g., based on end user preference. Such manual adjustment offset can be stored for future application to the particular program channel. The audio adjustment or offset information can be associated with and/or included as part of the multimedia content, e.g., in the form of metadata transmitted with the multimedia content or separately from the multimedia content. Also, an additional program channel mapping parameter can be defined to include at least a portion of the audio adjustment or offset information.

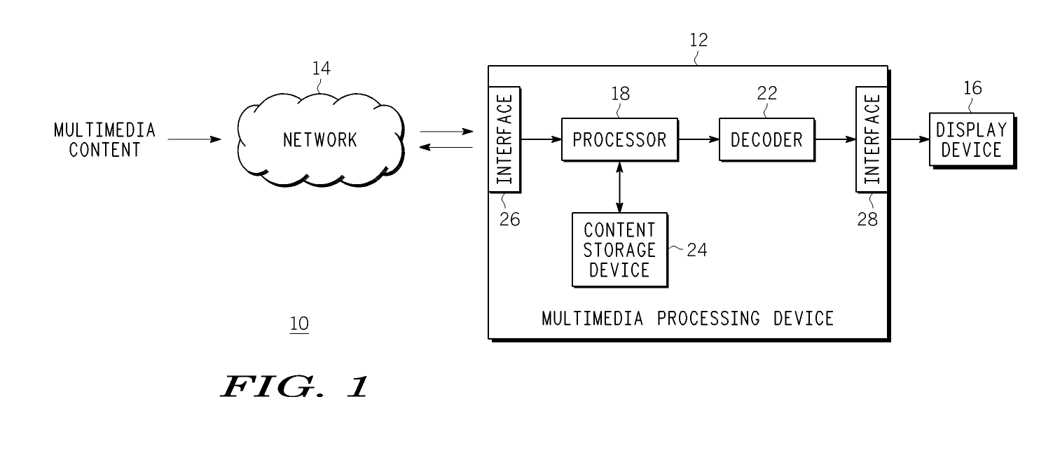

Referring now to FIG. 1, shown is a block diagram of a system 10 for adjusting audio levels of program channels of multimedia content. The system 10 includes a multimedia content source or server (not shown) for providing multimedia content, and a multimedia processing device 12 configured for receiving multimedia content.

The multimedia content source or server can be any suitable transmission source of multimedia content, such as over-the-air broadcasters, from a cable television plant, satellite service provider or other multimedia service provider. Also, the multimedia content source or server can be a serving device in the end user home, such as a personal computer (PC), a digital music player, such as an MP3 player, and/or a compact disc (CD) jukebox. The multimedia content source can be connected to the multimedia processing device 12 via any suitable connection, e.g., one or more coaxial cables and/or optical fibers, including a Hybrid Fiber Coaxial (HFC) cable system. Other suitable connections include suitable Fiber To The Premises (FTTP) systems, such as Fiber To The Curb (FTTC) or Fiber To The Home (FTTH), over any suitable number of digital subscriber line systems (xDSL), or over a wired or wireless Internet Protocol (IP) connection. Also, the multimedia content can be provided wirelessly, e.g., via over-the-air-broadcast from a satellite service provider or other suitable content service provider.

The multimedia content can be any suitable multimedia content, such as broadcast video, including movies, programming events and/or other multimedia content that is distributed, e.g., as one or more programming streams from a broadcast source or other suitable multimedia content source. Multimedia content also can include music and other audio content from audio-only services, as well as mixtures of audio and audio/video content from appropriate audio/video services. The multimedia content typically is a plurality of digital signals formatted according to a suitable standard, such as the MPEG-2 (Moving Picture Experts Group) or MPEG-4 standard, and multiplexed into a data stream that is modulated on a carrier using quadrature amplitude modulation (QAM) or other suitable modulation technique.

The multimedia content typically is broadcast or transmitted in the form of one or more program channels of multimedia content. Multimedia content also can be delivered to an end user point-to-point, e.g., in response to an end user request to an on-demand system or from a local or remote end user library. The program channels of multimedia content typically are managed by a channel map or channel mapping function in the multimedia processing device or other appropriate location. In general, the channel map defines or maps each program channel by a channel-specific set of parameter values for a given set of program channel parameters, such as a channel radio frequency (RF) band, modulation mode, program number, channel name and other suitable channel parameters. As will be discussed in greater detail hereinbelow, the channel mapping can include mapping an additional parameter for one or more possible audio adjustment or offset values for each program channel or each of a portion or group of the program channels.

The multimedia processing device 12 can be coupled to the multimedia content source via one or more networks 14. The network 14 can be any communication network or network server arrangement suitable for transmitting multimedia content to one or more multimedia processing devices 12. For example, the network 14 can be or include the Internet or an Internet protocol (IP) based network, or other suitable public network. The network 14 also can be or include a computer network, a web-based network or other suitable wired or wireless network or network system, including in-home personal networks.

The multimedia processing device 12 can be partially or completely any suitable device or subsystem (or portion thereof) for receiving multimedia content from the content source, processing or decoding the received multimedia content, and transmitting or transferring the processed multimedia content to an end user display device 16, such as a television, a stereo, a computer monitor or other suitable display device. Although the display device 16 is shown as a separate component from the multimedia processing device 12, it should be understood that the display device 16 and the multimedia processing device 12 can be combined or integrated as a single component.

Suitable multimedia processing devices include any multimedia content receiving, processing, storing and/or viewing device, such as any signal converter or decoder (set-top) box, including set-top boxes with internal and/or external recording capabilities and local and/or remote storage, which often are referred to as personal video recorder (PVR) devices, digital video recorder (DVR) devices and/or digital video server (DVS) devices. Other suitable multimedia processing devices include residential gateways, home media server systems, digital video disk recorders, computers, televisions with built-in or added-on video content receiving and storing capability, and/or other suitable computing devices or video devices, including internet protocol (IP), satellite and cable digital video recorders, and home area network (HAN) devices and systems. Still other suitable multimedia processing devices can include mobile and handheld computing devices, such as cellular telephones, smart telephones, personal digital assistants (PDAs), wireless handheld devices, digital cameras, mobile communication devices, music players, laptop personal computers (PCs) and notebook PCs.

The multimedia processing device 12 includes a processor or processing unit 18 and a decoder 22 coupled to the processor 18. The multimedia processing device 12 also can include an optional content storage element or device 24 coupled to the processor 18. In general, the processor 18 processes multimedia content and other information received by the multimedia processing device 12. In addition to the content storage device 24, the processor 18 can include at least one type of memory or memory unit (not shown) and a storage unit or data storage unit coupled to the processor for storing processing instructions and/or information, such as channel map information, received and/or created by the multimedia processing device 12. The decoder 22 typically decodes or decompresses the multimedia content to make it suitable for display, e.g., by the end user display device 16. Although the decoder 22 is shown coming after the processor 18 in the component arrangement of multimedia processing device 12, it should be understood that the decoder 22 can come before the processor 18, i.e., the multimedia content can be decoded or decompressed prior to further processing by the processor 18.

The multimedia processing device 12 also can include one or more input and/or output interfaces for receiving and/or transmitting multimedia content and other data and information. For example, the processor 18 and other components in the multimedia processing device 12 can be coupled between a first or input interface 26, which receives multimedia content from the content source, and a second or output interface 28, which transfers processed multimedia content, including stored multimedia content, to the end user display device 16. It should be understood that one or more of the interfaces 26, 28 can be a single input/output interface coupled to the processor 18. Also, it should be understood that one or more of the interfaces 26, 28 can be an interface configured to support more than one content source and/or display device.

One or more of the processor 18, the decoder 22, the content storage device 24 and the interfaces 26, 28 can be comprised partially or completely of any suitable structure or arrangement, e.g., one or more integrated circuits. Also, it should be understood that the multimedia processing device 12 includes other components, hardware and software (not shown) that are used for the operation of other features and functions of the multimedia processing device 12 not specifically described herein.

The multimedia processing device 12 can be partially or completely configured in the form of hardware circuitry and/or other hardware components within a larger device or group of components. Alternatively, the multimedia processing device 12 can be partially or completely configured in the form of software, e.g., as processing instructions and/or one or more sets of logic or computer code. In such configuration, the logic or processing instructions typically are stored in a data storage device, e.g., the content storage device 24 or other suitable data storage device (not shown). The data storage device typically is coupled to a processor or controller, e.g., the processor 18. The processor accesses the necessary instructions from the data storage device and executes the instructions or transfers the instructions to the appropriate location within the multimedia processing device 12.

With respect to the content storage device 24, multimedia processing devices typically include or have access to a hard drive or other storage element for recording streams of multimedia content, such as video streams broadcast from the multimedia content source. However, the content storage device 24 can be any suitable information storage unit, such as any suitable magnetic storage or optical storage device, including magnetic disk drives, magnetic disks, optical drives, optical disks, and memory devices, including random access memory (RAM) devices and flash memory. Also, although the content storage device 24 is shown within the multimedia processing device 12, the content storage device 24 can be located external to the multimedia processing device 12 and suitably coupled thereto.

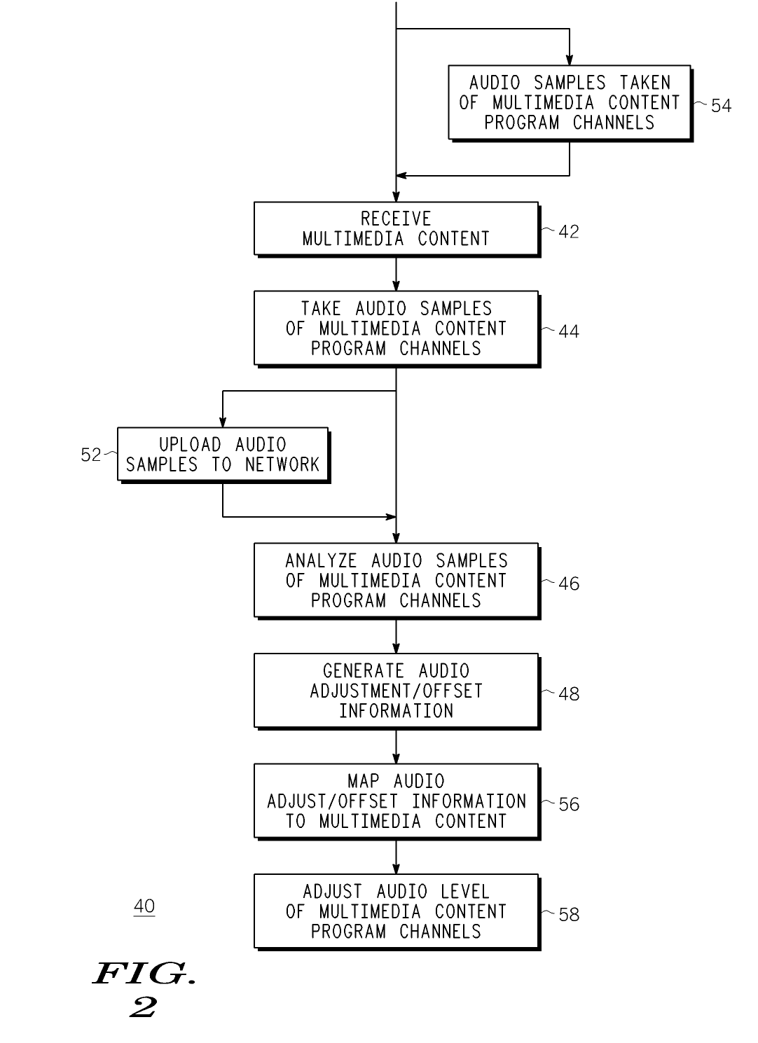

Referring now to FIG. 2, with continuing reference to FIG. 1, shown is a flow chart that schematically illustrates a method 40 for adjusting audio levels of program channels of multimedia content. The method 40 includes a step 42 of receiving multimedia content, e.g., by the multimedia processing device 12. The multimedia content, which typically is transmitted from an appropriate content source, e.g., via the network 14, typically is received by the multimedia processing device 12 by the input interface 26 and transferred to the processor 18. To receive the multimedia content, the multimedia processing device 12 may include one or more receiving components (not shown), such as a radio frequency (RF) tuner, a QAM demodulator, an MPEG stream demultiplexor and a conditional access decryptor or decrypting module.

As discussed hereinabove, the multimedia content can be any suitable multimedia content, such as broadcast video. The multimedia content is broadcast or distributed in any suitable manner, e.g., as one or more programming streams, typically in the form of one or more program channels of multimedia content. The multimedia content program channels typically are defined by a channel map or channel mapping function that, in general, defines or maps each program channel by a set of unique parameter values for a given set of program channel parameters. For example, the channel mapping parameters include channel radio frequency (RF) band, modulation mode, channel name, program number and other distinguishing program channel parameters. As will be discussed in greater detail hereinbelow, according to the audio level method 40, the channel mapping can include mapping an additional parameter for one or more possible audio adjustment or offset values for one or more of the program channels and/or one or more portions or groups of the program channels.

The method 40 also includes a step 44 of taking audio level samples of one or more of the multimedia content program channels. Typically, one or more samples of the audio level of all or a portion of the multimedia content program channels is taken by the processor 18 or other appropriate component within the multimedia processing device 12, such as one or more audio level detectors and/or integrators that are part of or coupled to the processor 18. The audio level samples can be taken in real time as the multimedia content is received by the multimedia processing device 12. Alternatively, audio level samples can be taken from a portion of the multimedia content received by the multimedia processing device 12 and stored, e.g., temporarily, in the content storage device 24. Also, alternatively, audio level samples of the multimedia content can be taken by one or more suitable components within the network 14, i.e., prior to the multimedia content being transmitted to and received by the multimedia processing device 12.

According to the step 44, at least one audio level sample is taken from at least two different program channels of multimedia content. However, typically, a plurality of audio level samples are taken from each of the program channels of multimedia content, e.g., at different times or points during or along the video stream, possibly over a time period of several days. In general, having more samples per time period taken of a given program channel provides a better assessment of the overall audio level of the particular program channel. Typically, the audio level samples are taken or measured in decibels (dB), although the audio level samples can be measured or taken in any suitable unit or form.

The audio level samples taken can be of any suitable duration, e.g., from several second to several minutes, and can include more than one audio level sampling per audio level sample. For example, for a given program channel, an audio level sample can be a single 15 second continuous sample or, alternatively, can be several 5 second continuous samples with 5-25 second skipped sections therebetween. In such example, after approximately 10 minutes of elapsed time, there would be a sample duration of approximately 100 seconds. However, the 100-second sample includes 5 seconds of each half-minute of program channel content over the 10 minutes of sampled program channel content.

The audio level samples can be taken over any suitable period of time. For example, a series of 15 second audio level samples can be taken periodically over several hours to several days, e.g., with weekly or monthly updates. Also, the audio level samples can be taken at any suitable time during the particular program content. For example, for video programming channel content, commercials between segments of programming content typically occur at the top and bottom of each hour. Therefore, audio level samples can be taken at times other than when commercials are known to occur. It should be understood that any suitable audio level sampling rate and/or pattern can be used to acquire any suitable number of audio level samples or any suitable duration.

The method 40 also includes a step 46 of analyzing the audio level samples to determine the audio level for the program channel. The analysis step 46 can be performed by the processor 18 or other suitable component or components within the multimedia processing device 12. Alternatively, as will be discussed hereinbelow, the analysis can be performed external to the multimedia processing device 12, e.g., by one or more suitable components in the network 14 or other suitable location.

The analysis can use any suitable algorithm or other means to compute the overall sound level of the audio level samples for the given program channel. Some analysis methods may include attempts to distinguish human voices, e.g., by their frequency characteristics and/or by the speed with which the sounds vary compared to other (non-voice) noises. Distinguishing human voices within the audio level samples may assist in ultimately matching perceived audio level variations between program channels. As will be discussed in greater detail hereinbelow, the result of this analysis is used to compute the offset for storage in the channel map and then later dialed into the multimedia processing device audio reproduction circuitry each time the end user tunes that program channel.

The method 40 also includes a step 48 of generating audio adjustment or offset information. Audio adjustment or offset information is information, typically associated with one or more program channels of multimedia content, that is used to potentially adjust the audio level of one or more program channels of multimedia content. Typically, the step 48 generates audio adjustment or offset information based on the samples taken from the sampling step 44 and the analysis of the samples in the analysis step 46. However, it should be understood that other criteria can be used wholly or partially as the basis for generating audio adjustment or offset information.

The results of the analysis step 46 for a given program channel can be compared to the audio levels measured for some or all other program channels to determine or establish offsets or offset values for each individual program channel of multimedia content to be computed. For example, the offsets or offset information can be stored in the channel map and/or a separate channel map file associated with the channel map, and then later dialed into the set top audio reproduction circuitry each time the consumer tunes that channel. The offsets added to the channel map could be in dB or they could be in arbitrary units that the circuit designer computed such that they match the characteristics of the set top volume control to which these offsets will be applied.

All or a portion of audio adjustment or offset information can be generated within the multimedia processing device 12, e.g., in the processor 18 or other suitable component or components within the multimedia processing device 12. Alternatively, all or a portion of audio adjustment or offset information can be generated external to the multimedia processing device 12, e.g., by one or more suitable components within the network 14.

Accordingly, the method 40 can include a step 52 of uploading or otherwise transmitting to the network 14 all or a portion of the audio level samples taken by the multimedia processing device 12. As discussed hereinabove, the multimedia processing device 12, e.g., using the processor 18, can take all or a portion of the audio level samples of multimedia content received by the multimedia processing device 12.

Alternatively, one or more suitable components within the network 14 can take audio level samples of the multimedia content, i.e., prior to the multimedia content being transmitted to the multimedia processing device 12. Accordingly, the method 40 can include a step 54 of taking audio level samples of one or more of the multimedia content program channels before the multimedia content is received by the multimedia processing device 12, i.e., before the receiving step 42.

If audio adjustment or offset information is to be generated by one or more suitable components within the network 14, i.e., external to the multimedia processing device 12, based on audio level samples taken by the multimedia processing device 12, then the uploading step 52 is performed to deliver at least some of the audio level samples, e.g., from the multimedia processing device 12, to the appropriate component or components within the network 14. If audio adjustment or offset information is to be generated by one or more components within the network 14, based on audio level samples taken by one or more components in the network 14, then the uploading step 52 may need not be performed. Also, if audio adjustment or offset information is to be generated within the multimedia processing device 12, based on audio level samples taken by the multimedia processing device 12, then the uploading step 52 may need not be performed.

In general, audio adjustment or offset information is information that can be used to adjust the audio level of one or more program channels of multimedia content, e.g., to reduce or offset differences between the audio levels of all or a portion of the program channels of the multimedia content relative to one another. Thus, for example, for one or more multimedia content program channels whose audio levels generally are greater than the audio levels of other program channels (e.g., greater than the overall average audio level of all the program channels), audio adjustment or offset information associated with those particular program channels may include an amount by which to reduce the audio levels of one or more of the louder program channels. The adjustment amount or amounts can be associated with or applied to all or a portion of the particular program channels of interest, including a specific adjustment amount for each program channel of interest.

Similarly, for one or more program channels whose audio levels generally are less than or quieter than the overall average audio level of all the program channels, audio adjustment or offset information for those quieter program channels may include an amount or amounts by which to increase their audio levels. Again, the audio adjustment or offset information can include one adjustment or offset amount to be applied to one or more of the quieter program channels. Alternatively, the audio adjustment or offset information can include a plurality of adjustment or offset amounts for a corresponding plurality of the quieter program channels, e.g., specific or individual adjustment amounts for each of the quieter program channels.

According to the method 40, audio adjustment or offset information can include one specific adjustment level for each program channel, one overall adjustment level for all program channels or a group of program channels, or some combination thereof. For example, audio adjustment or offset information can include less than one adjustment level per program channel, e.g., one adjustment level for applying to each program channel within various groups of program channels whose specific audio levels fall within a particular audio level range. Alternatively, audio adjustment or offset information can include one or more individual adjustment levels for each program channel of multimedia content and/or each program channel within a group of program channels.

The method 40 includes a step 56 of mapping or otherwise associating the audio adjustment or offset information to the multimedia content. Once generated, the audio adjustment or offset information has to be accessible by suitable components, e.g., the processor 18, and in a suitable form or format that can be read or decoded by those components. The step 56 maps or associates the audio adjustment information to the appropriate program channels and other portions of the multimedia content.

For example, the audio adjustment or offset information can be part of the multimedia content metadata, which typically includes program and program channel information, and typically is broadcast along with the video stream. In addition to the program and program channel information included in conventional metadata, the metadata can include audio adjustment information for one or more individual program channels or groups of program channels. For example, such metadata can be added to a part of the video stream in accordance with the Program and System Information Protocol (PSIP). Conventionally, Dolby Digital audio streams include such a dialnorm (dialog normalization) parameter for such purpose, however, the dialnorm value encoded in the stream is not always accurate. Upon receipt of the multimedia content by the multimedia processing device 12, the processor 18 or other appropriate component or components can read the metadata, including the audio adjustment information, and apply any audio level adjustments to one or more of program channels of multimedia content.

Alternatively, the audio adjustment or offset information can be part of program channel information metadata that is broadcast or transmitted separately form the program channel video stream. For example, if audio adjustment information is generated by the network 14 or otherwise generated external to the multimedia processing device 12, the audio adjustment information can be transmitted to the multimedia processing device 12 prior to or after the transmission of its associated multimedia content. Often, the channel map for the multimedia processing device 12 is transmitted to the multimedia processing device 12 from the network 14. Thus, an audio adjustment or offset parameter can be added as another field to the channel map. Also, the audio adjustment information can be transmitted in any suitable form or format that can be read or otherwise accessed by the appropriate decoding and audio level adjustment components within the multimedia processing device 12, such as the processor 18.

For example, the audio adjustment information can be transmitted in the form of a lookup table that is suitable for the multimedia processing device 12 to associate the various lookup table entries, e.g., including audio adjustment information, to various multimedia content program channels or groups of program channels of the received multimedia content. In this manner, the processor 18 or other appropriate components within the multimedia processing device 12 can make the necessary audio level adjustments to the various program channels of multimedia content as the multimedia content is being received by the multimedia processing device 12.

Alternatively, the step 56 can map or associate audio adjustment information to the appropriate program channels and other portions of the multimedia content by adding such information in one or more multimedia content program channel maps and/or associated channel map files that are stored in the multimedia processing device 12. As discussed hereinabove, multimedia content program channels typically are defined by a channel map or channel mapping function, which includes various channel-specific information for various program channel parameters. Such parameters include channel radio frequency (RF) band, modulation mode, channel name, program number and other program channel parameters. According to the method 40, the step 56 can include or define an additional parameter in the channel map for audio level adjustment or offset information.

The method 40 includes a step 58 of adjusting the audio level of one or more program channels of multimedia content. Typically, one or more multimedia content program channels are adjusted based on the audio level samples taken and/or the generated audio level adjustment information, although other suitable information can be used along with such information as at least a partial basis for audio level adjustment of one or more multimedia content program channels. The result of the audio level adjustment is that the program channels are perceived to be approximately the same loudness relative to one another.

The audio adjustment step 58 can be performed in suitable manner. For example, the audio level of one or more program channels of multimedia content can be adjusted manually by an end user. For example, the multimedia processing device 12 can be configured to allow an end user to manually adjust the audio level of one or more multimedia content program channels, e.g., based on the individual preference of the end user. Alternatively, manual adjustment also can take into consideration other information, such as any audio level samples that may have been taken of various channels and any audio adjustment information that may have been generated.

Manual adjustment can occur as part of an initial setup process involving the multimedia processing device 12, e.g., upon initial power-up of the multimedia processing device 12, or, alternatively, at any suitable time during the operation of the multimedia processing device 12. For example, the multimedia processing device 12 can be configured in such a way that manual adjustment can occur by monitoring the volume up/down behavior of the end user as the end user changes program channels (i.e., channel surfs). The up/down adjustments made by the end user can be used as the basis for offset values that get added to the channel map. In this manner, manual adjustment occurs without the end user being consciously aware that they are calibrating the program channel audio level offsets.

Alternatively, the audio adjustment step 58 can be performed automatically by the multimedia processing device 12, e.g., upon start-up or as part of any program channel tuning setup feature for which the multimedia processing device 12 is configured to perform. Thus, for example, as the multimedia processing device 12 is tuning itself (when not in use by the end user) to receive various program channels that are included in the received multimedia content, the multimedia processing device 12 also can be accessing audio adjustment information and adjusting the audio level of each tuned program channel. As discussed hereinabove, the audio adjustment information can be contained within the metadata associated with the received multimedia content and/or in a channel map transmitted with the multimedia content and/or stored in the multimedia processing device.

Also, alternatively, the audio adjustment step 58 can be performed by the network 14, e.g., automatically, prior to the multimedia content being transmitted to the multimedia processing device 12. In this manner, the network 14 can access audio adjustment information and adjust the audio level of one or more multimedia content program channels before the multimedia content is transmitted to the multimedia processing device 12. The accessed audio adjustment information can be stored within the network 14 and/or transmitted to the network 14 by the multimedia processing device 12 or other appropriate component, e.g., by the multimedia content source or provider. Alternatively, the network 14 can generate the audio adjustment information based on audio level samples or other suitable information associated with the multimedia content. The audio level samples can be taken or generated by the network 14 and/or by the multimedia processing device 12 and/or other suitable system components and transmitted to the network 14.

It should be understood that, within the system 10, it is not required that audio level samples be taken and actually saved or stored, even temporarily, for analysis. The multimedia processing device 12 and/or one or more components in the network 14 can be configured to at least partially sample audio levels of program channels, perform analysis and provide adjustment to program channel audio levels in real time, i.e., as an end user is watching a particular program channel. Alternatively, audio level sampling, analysis and adjustment can be performed as part of any real-time analysis of a program channel soundtrack.

Also, audio level sampling, analysis and adjustment can be performed as a background task, i.e., when viewing and other processing resources are not be used. For example, audio level samples can be taken and written to memory/disk, and then analysis can be performed as a background task running as fast or slow as the configuration of the particular multimedia processing device 12 will support.

Alternatively, audio level samples can be taken and sent to one or more computation devices in the network for at least a portion of the analysis and generation of the offset information. Also, alternatively, audio level sampling, analysis and adjustment can be performed directly in whole and/or in part by a computation device in the network. In this manner, at least a portion of the adjustment information added to the channel map and/or the program channels can be adjusted prior to the multimedia content being transmitted to the end user multimedia processing device.

Moreover, alternatively, the sampling and analysis can be a combination or mix of local and network processing. For example, the audio level analysis for some of the content can be performed in the network 14 (e.g., the cable operators content) and some audio level analysis can be performed in the multimedia processing device 12, (e.g., the local home network content). That is, network-based processing can be used for those services provided by a particular service provider, e.g., the cable or satellite service provider, and local device processing is used to compute the audio level offsets for content from other sources, like the in-home network or some third party internet service provider. Also, for example, the multimedia processing device 12 can partially processes the audio samples before uploading the audio samples to the network 14 and its processing components to make better use of available system resources, which may include computing power in both the multimedia processing device 12 and the network 14, and to possibly minimize (or otherwise optimize) the amount of data that is or needs to be sent to the network 14.

Also, depending on the particular source or sources of multimedia content and the network or networks being used by a similar group of end users, e.g., subscribers in the same immediate area receiving content from the same service provider, it may be that the same or similar adjustments and offsets are sufficient for most if not all end users via their respective multimedia processing devices. Therefore, a reduced set of offset information can be generated and applied equally or almost equally across most if not all end users within a similar end user group. For example, such information can be shared across all subscribers in a given network, and then shared across all multimedia processing devices within the given network. In this manner, the time and expense associated with audio level adjustment can be substantially reduced by such sharing efforts.

For multimedia content transmitted in accordance with one or more Dolby Digital Sony/Philips Digital Interface Format (S/PDIF) protocols, audio level adjustments can be made in any suitable manner, e.g., by adjusting the Dolby Digital bit stream value of the dialnorm (dialog normalization) parameter based on the audio adjustment or offset information within the constraints of the Dolby specification. Such adjustment typically would be made prior to the S/PDIF audio being output by the multimedia processing device 12, e.g., to the display device 16.

The method shown in FIG. 2 may be implemented in a general, multi-purpose or single purpose processor. Such a processor will execute instructions, either at the assembly, compiled or machine-level, to perform that process. Those instructions can be written by one of ordinary skill in the art following the description of FIG. 2 and stored or transmitted on a computer readable medium. The instructions may also be created using source code or any other known computer-aided design tool. A computer readable medium may be any medium capable of carrying those instructions and includes random access memory (RAM), dynamic RAM (DRAM), flash memory, read-only memory (ROM), compact disk ROM (CD-ROM), digital video disks (DVDs), magnetic disks or tapes, optical disks or other disks, silicon memory (e.g., removable, non-removable, volatile or non-volatile), packetized or non-packetized wireline or wireless transmission signals.

It will be apparent to those skilled in the art that many changes and substitutions can be made to the multimedia processing device and method for adjusting audio levels of channels of multimedia content herein described without departing from the spirit and scope of the invention as defined by the appended claims and their full scope of equivalents.

1. A multimedia processing device, comprising:
a processor configured to receive multimedia content, wherein the multimedia content includes at least one program channel of multimedia content,
wherein the processor is configured to adjust the audio level of at least one multimedia content program channel based on audio adjustment information associated with the at least one multimedia content program channel; and
a memory element coupled to the processor for storing at least one of at least a portion of the multimedia content received by the processor and at least a portion of the audio adjustment information associated with the at least one multimedia content program channel.

2. The device as recited in claim 1, wherein the audio adjustment information is generated based on at least one audio level sample from each of a plurality of program channels of multimedia content.

3. The device as recited in claim 1, wherein at least a portion of the audio adjustment information for at least one program channel of multimedia content is generated by the processor based on audio level samples from a plurality of program channels of multimedia content.

4. The device as recited in claim 1, wherein at least a portion of the audio adjustment information for at least one program channel of multimedia content is generated external to the multimedia processing device.

5. The device as recited in claim 1, wherein the multimedia content has associated therewith at least one channel map having at least one channel parameter, and wherein at least a portion of the audio level adjustment information is at least one of added to the channel map and associated with the channel map.

6. The device as recited in claim 1, wherein the multimedia content includes metadata that includes information about the program channels in the multimedia content, and wherein at least a portion of the audio level adjustment information is included in the metadata.

7. The device as recited in claim 6, wherein the metadata is transmitted separately from the multimedia content.

8. The device as recited in claim 1, wherein the processor is configured to display multimedia content on a display device coupled to the multimedia processing device, and wherein the processor is configured to adjust the audio level of at least one multimedia content program channel as at least a portion of the multimedia content is being displayed by the multimedia processing device on the display device.

9. The device as recited in claim 1, wherein the audio adjustment information for at least one program channel of multimedia content is input manually by an end user.

10. The device as recited in claim 1, wherein the multimedia processing device is selected from the group consisting of a signal converter box, a signal decoder box, a digital video recorder, a digital video disk recorder, a personal video recorder device, a home media server, a digital video server, a residential gateway, a video receiver and a computer.

11. A method for operating a multimedia processing device, comprising the steps of:
receiving multimedia content by the multimedia processing device, wherein the multimedia content includes at least one program channel of multimedia content;
generating audio adjustment information associated with at least one program channel of multimedia content; and
adjusting the audio level of the at least one program channel of multimedia content based on the audio adjustment information associated with the at least one multimedia content program channel.

12. The method as recited in claim 11, further comprising a step of taking at least one audio level sample from each of a plurality of program channels of multimedia content, wherein at least a portion of the sample taking step is performed in at least one of the multimedia processing device and a multimedia content network coupled to the multimedia processing device, and wherein the generating step includes generating the audio adjustment information based on at least a portion of the audio level samples.

13. The method as recited in claim 12, further comprising a step of analyzing at least a portion of the audio level samples, wherein at least a portion of the analyzing step is performed in at least one of the multimedia processing device and a multimedia content network coupled to the multimedia processing device, and wherein the generating step includes generating the audio adjustment information based on the analysis of at least a portion of the audio level samples.

14. The method as recited in claim 11, wherein at least a portion of the generating step is performed in at least one of the multimedia processing device and a multimedia content network coupled to the multimedia processing device.

15. The method as recited in claim 11, wherein the multimedia content has associated therewith a channel map that defines at least one parameter for at least one multimedia content program channel, and wherein the method includes a step of defining at least one audio level offset parameter in the channel map for at least one multimedia content program channel.

16. The method as recited in claim 11, wherein the generating step includes the multimedia processing device generating audio adjustment information for at least one program channel of multimedia content based on a plurality of audio level samples associated with a plurality of program channels of multimedia content.

17. The method as recited in claim 11, further comprising the steps of taking at least one audio level sample from a plurality of program channels of multimedia content and uploading at least a portion of the audio level samples to a multimedia content network coupled to the multimedia processing device, wherein the generating step is performed in the multimedia content network, and wherein the method further comprises the step of transmitting the audio adjustment information from the multimedia content network to the multimedia processing device.

18. The method as recited in claim 11, wherein at least a portion of the audio adjustment information is included as part of multimedia content as metadata.

19. The method as recited in claim 11, wherein at least a portion of the audio adjustment information is transmitted to the multimedia processing device separately from the multimedia content as metadata.

20. The method as recited in claim 11, wherein the generating step includes an end user manually entering into the multimedia processing device at least a portion of the audio adjustment information for at least one program channel of multimedia content.
